(19) United States
(12) Patent Application Publication
(10) Pub. No.: US 2025/0028519 A1
(43) Pub. Date: Jan. 23, 2025

(54) METHODS AND APPARATUS TO MANAGE SINGLE-COMPLIANCE DESIGNS FOR CLOUD, ON-PREMISES AND DARK SITE DEPLOYMENTS

(71) Applicant: VMware LLC, Palo Alto, CA (US)

(72) Inventors: Nilesh Vishwas Kamble, Bangalore (IN); Naren Lal, Bangalore (IN); Akshay Anand, Bangalore (IN); Raj Shekar Chelur, Cary, NC (US); Yogendra Baldev Bhasin, Fremont, CA (US)

(21) Appl. No.: 18/380,273

(22) Filed: Oct. 16, 2023

(30) Foreign Application Priority Data
Jul. 20, 2023 (IN) 202341048929

(51) Int. Cl. G06F 8/65

(52) U.S. Cl. CPC G06F 8/65

(57) ABSTRACT

An example disclosed system includes programmable circuitry to at least one of instantiate or execute instructions to update a compliance rule based on a target compliance definition to generate a target compliance rule, the compliance rule corresponding to a resource in a software defined data center, and output configuration update information based on a comparison of the target compliance rule with a current resource configuration, the current resource configuration corresponding to the resource in the software defined data center.

### RELATED APPLICATIONS

Benefit is claimed under 35 U.S.C. 119 (a)-(d) to Foreign application No. 202341048929 filed in India entitled “METHODS AND APPARATUS TO MANAGE SINGLE-COMPLIANCE DESIGNS FOR CLOUD, ON-PREMISES AND DARK SITE DEPLOYMENTS”, on Jul. 20, 2023, by VMware, Inc., which is herein incorporated in its entirety by reference for all purposes.

### FIELD OF THE DISCLOSURE

This disclosure relates generally to cloud computing and, more particularly, to methods and apparatus to manage single-compliance designs for cloud, on-premises and dark site deployments.

### BACKGROUND

Large enterprises comply with regulatory standards that are driven by industry guidelines and/or generally specified by regional laws. As compliance configurations are continuously changing to meet industry standards, customers rely on Software-as-a-Service (SaaS) solutions to maintain compliance. SaaS-based solutions allow cloud-connected workloads and cloud-disconnected workloads like dark sites (where data centers are not connected to public networks) to achieve compliance.

### BRIEF DESCRIPTION OF THE DRAWINGS

FIG. 1 is a block diagram of an example environment in which an example compliance service and compliance agent operate to manage compliance for cloud, on-premises and dark site deployments.

FIG. 2 is an example implementation of the compliance service of FIG. 1.

FIG. 3 is an example implementation of the compliance agent of FIG. 1.

FIG. 4 is an example apparatus that may be used to implement the compliance service of FIG. 2.

FIG. 5 is an example apparatus that may be used to implement the compliance agent of FIG. 3.

FIG. 6 is a flowchart representative of example machine readable instructions and/or example operations that may be executed, instantiated, and/or performed by example programmable circuitry to implement aspects of the compliance system represented in FIG. 1, FIG. 2, FIG. 3, and/or FIG. 4.

FIG. 7 is a flowchart representative of example machine readable instructions and/or example operations that may be executed, instantiated, and/or performed by example programmable circuitry to implement the compliance service of FIG. 1, FIG. 2 and FIG. 4 to perform a compliance audit.

FIG. 8 is a flowchart representative of example machine readable instructions and/or example operations that may be executed, instantiated, and/or performed by example programmable circuitry to implement the compliance service of FIG. 1, FIG. 2 and FIG. 4 to perform remediation.

FIG. 9 is a flowchart representative of example machine readable instructions and/or example operations that may be executed, instantiated, and/or performed by example programmable circuitry to implement the compliance agent of FIG. 1, FIG. 3 and FIG. 5 to perform an agent compliance audit.

FIG. 10 is a block diagram of an example processing platform including programmable circuitry structured to execute, instantiate, and/or perform the example machine readable instructions and/or perform the example operations of FIGS. 6-8 to implement the example compliance service of FIGS. 1, 2, and 4.

FIG. 11 is a block diagram of an example processing platform including programmable circuitry structured to execute, instantiate, and/or perform the example machine readable instructions and/or perform the example operations of FIGS. 6 and 9 to implement the example compliance agent of FIGS. 1, 3, and 5.

FIG. 12 is a block diagram of an example implementation of the programmable circuitry of FIGS. 10 and 11.

FIG. 13 is a block diagram of another example implementation of the programmable circuitry of FIGS. 10 and 11.

FIG. 14 is a block diagram of an example software/firmware/instructions distribution platform (e.g., one or more servers) to distribute software, instructions, and/or firmware (e.g., corresponding to the example machine readable instructions of FIGS. 6-9 to devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to within one second of real time.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

Cloud compliance refers to complying with regulatory security standards that are driven by industry guidelines and are specific to regional laws. Few solutions exist for compliance management of Software Defined Data Center (SDDC) solutions and as cloud security becomes stricter, compliance standards enforcement requires that the cloud infrastructure and applications deployed remain compliant. It has become a pre-requisite that only SDDC products that are certified against certain compliance standards are eligible for customer adoption. Customers can also be empowered to maintain continuous compliance with the cloud. Prior SaaS-based solutions are available for cloud deployments of SDDCs to maintain compliance with industry standards. However, SaaS-based solutions are only available to cloud-connected workloads. Cloud-disconnected workloads such as dark sites, where data centers are not connected to a public network cannot use SaaS-based offerings to maintain compliance. For deployments in cloud-disconnected environments (e.g., dark sites), customers do not have an outside connection to their inventory due to security reasons, internal guidelines, etc. Prior cloud-based compliance solutions do not work in cloud-disconnected environments. Examples disclosed herein may be used to implement a compliance solution that can work on any deployment of an SDDC, provides an ability to audit the compliance of products deployed in an SDDC and can harden the configurations to achieve the desired compliance.

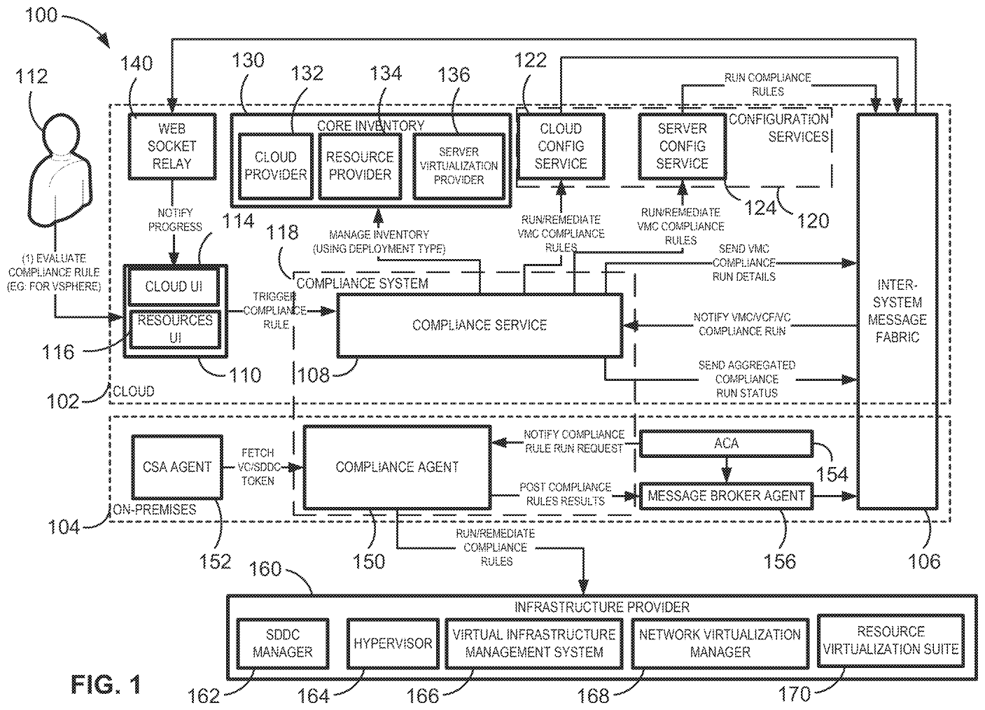

FIG. 1 is a block diagram of an example environment 100 in which an example compliance service 108 and an example compliance agent 150 operate to manage compliance for cloud deployments, on-premises deployments, and/or dark site deployments. In examples disclosed herein, the compliance service 108 and the compliance agent 150 together form a compliance system 118. The example compliance system 118 provides compliance management of any deployment of SDDCs. The illustrated example environment 100 includes a cloud system 102 and an on-premises system 104. An example inter-system message fabric 106 is shared between the cloud system 102 and the on-premises system 104 for communications therebetween.

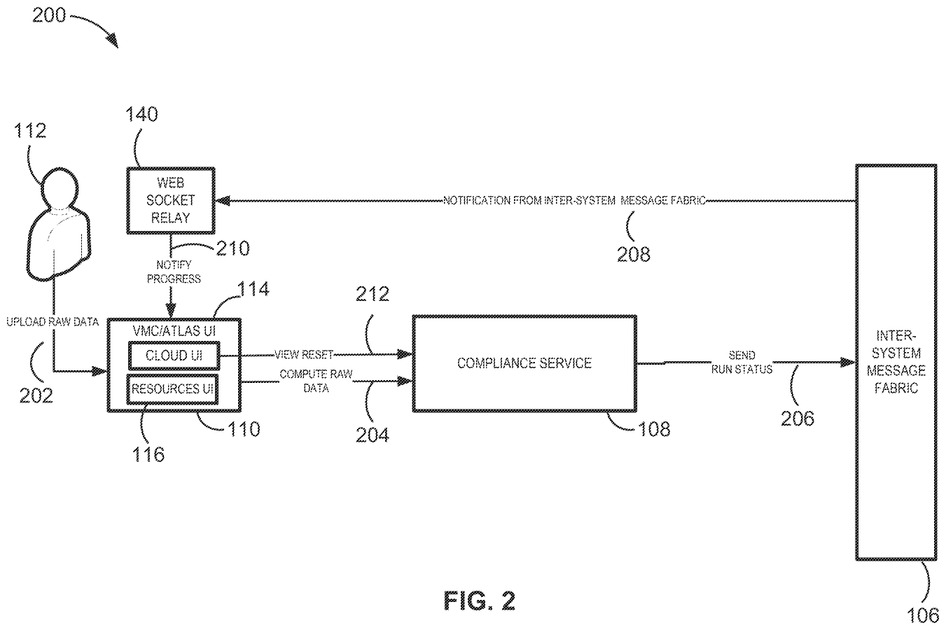

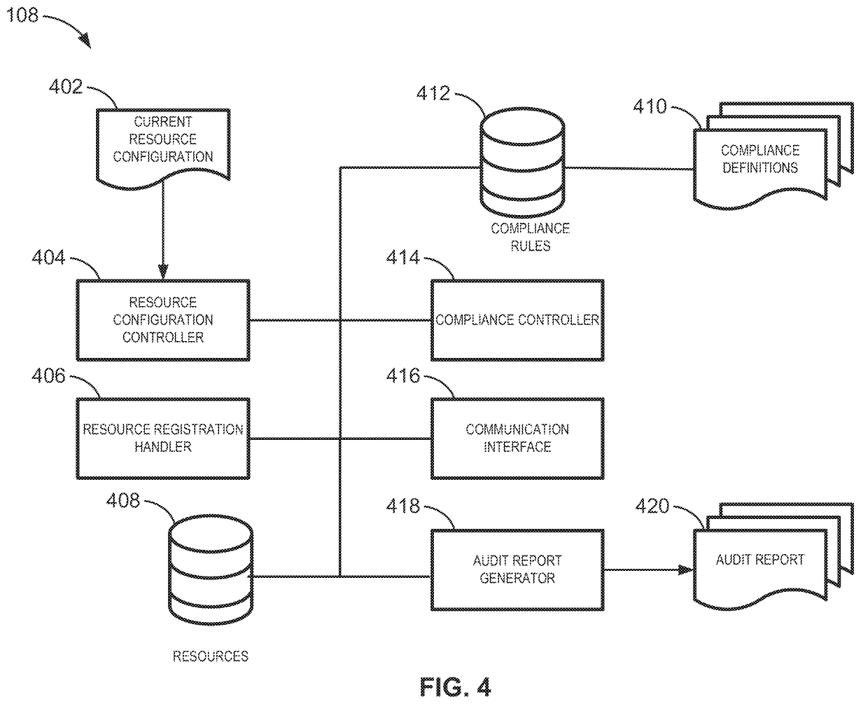

The example cloud system 102 includes the compliance service 108 to trigger audit processes or remediation processes on SDDCs and to render compliance reports of infrastructure components corresponding to the SDDCs. The example compliance service 108 is described in more detail below in connection with FIG. 2 and FIG. 4. The example cloud system 102 also includes a cloud console user interface (UI) 110 for users or cloud administrators 112 to interact with the compliance service 108, a configuration service 120 to trigger compliance workflows on resources deployed in different environments, a core inventory database 130 to store resource inventories of different deployments, and a web socket relay (WSR) 140 to relay messages.

The example compliance service 108 is a micro-service in the cloud that triggers audit or remediation on SDDCs that use, for example, cloud provider platforms 132, resource providers 134, standalone server virtualization provider platforms 136, etc. In some examples, a cloud provider platform 132 may be implemented using VMware Cloud (VMC) developed and provided by VMware, Inc. of Palo Alto, California, United States of America, a resource provider 134 may be implemented using VMware Cloud Foundation (VCF) developed and provided by VMware, Inc., and a standalone server virtualization provider platform 136 may be implemented using VMware vSphere developed and provided by VMware, Inc. The example compliance service 108 can be implemented using a cloud-hosted VMWare Site Reliability Engineering (SRE) service developed and provided by VMware, Inc. The example compliance service 108 enables users to view compliance reports of infrastructure components. In example FIG. 1, the user or cloud administrator 112 can trigger an audit of the SDDC from the cloud console user interface 110 using a cloud UI 114 and/or a resources UI 116. The example cloud console user interface 110 may be implemented using a VMware Cloud Services Console developed and provided by VMware, Inc. The example configuration services 120 include a cloud configuration service 122 and a server configuration service 124. For cloud use cases (e.g., cloud deployments based on VMC), compliance audit or remediation is delegated to the cloud configuration service 122. The cloud configuration service 122 is responsible for triggering compliance workflow on cloud resources. In some examples, cloud deployments use server resources (e.g., server resources managed by VMware vCenter server management software developed and provided by VMware, Inc.). For such use cases, the server configuration service 124 manages triggers for compliance workflows on server resources deployed in the environment.

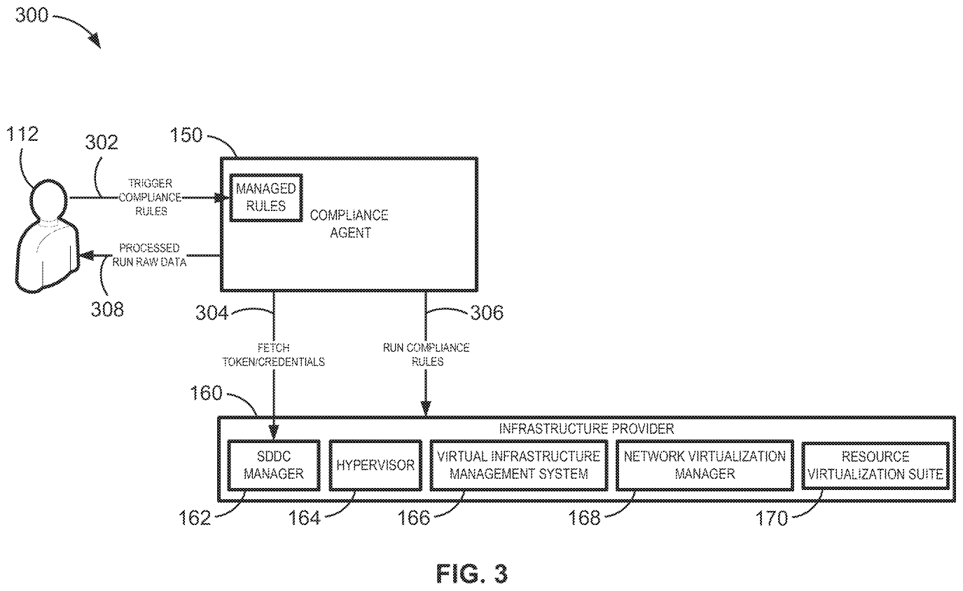

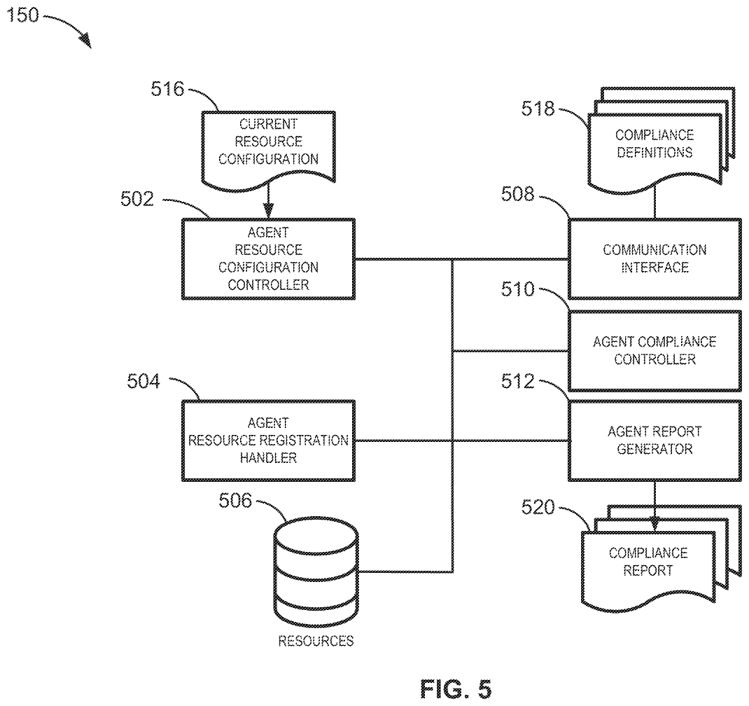

The example on-premises system 104 includes the compliance agent 150, a cloud service availability (CSA) agent 152, an agent-coordination agent (ACA) 154, a message broker agent 156, and the inter-system message fabric 106. The example compliance agent 150, or sometimes referred to as the cloud gateway agent, evaluates compliance rules and remediates SDDC configurations to achieve compliance for on-premises deployments. The example compliance agent 150 is described in more detail below in connection with FIG. 3 and FIG. 5. The example CSA agent 152 provides resource tokens or credentials to the compliance agent 150 for use in executing compliance rules directly to on-premises resources. The example CSA agent 152 may be implemented using a Disaster Recovery-as-a-Service (DRaaS) such as VMWare Cloud Director Availability™ software developed and provided by VMware, Inc. The example ACA 154 is provided to create an instance of the compliance agent 150 as a container in a namespace of a container orchestration system such as Kubernetes. On bootstrap, the example compliance agent 150 registers the SDDC with the compliance service 108 in the cloud system 102. The example compliance agent 150 then continuously communicates with the example message broker agent 156 to poll for compliance audit requests from the compliance service 108 via the inter-system message fabric 106. The example compliance agent 150 evaluates target compliance rules in the compliance audit request against on-premises SDDC products.

The example on-premises system 104 is in communication with an infrastructure provider 160 that includes on-premises SDDC products such as a SDDC manager 162, an embedded hypervisor 164, a virtual infrastructure management system 166, a network virtualization manager 168, a resource virtualization suite 170, etc. The example embedded hypervisor 164 may be implemented using VMware ESXi® hypervisor developed and provided by VMware, Inc. The example virtual infrastructure management system 166 is a centralized and extensible platform for managing virtual infrastructures. The example virtual infrastructure management system 166 may be implemented using vCenter™ software suite developed and provided by VMware, Inc. The example resource virtualization suite 170 is a collection of components to set up and manage a virtual infrastructure of servers, networks, and other resources. The example virtualization suite 170 could be implemented using a VMware vSphere® virtualization suite developed and provided by VMware, Inc. An example network virtualization manager 168 includes a number of components to deploy and manage virtualized network resources across servers, switches, and clients. The example network virtualization manager 168 may be implemented using a VMware NSX® network virtualization manager developed and provided by VMware, Inc.

Cloud compliance refers to complying with regulatory security standards that are driven by industry guidelines that are specific to regional laws. A compliance standard is a representation of a list of compliance controls that is tested against an infrastructure to determine if the controls are followed. Examples of compliance standards are Payment Card Industry Data Security Standard (PCI-DSS), an information security standard used for payments and credit card industries, Health Insurance Portability and Accountability Act (HIPAA) regulatory standards for healthcare, etc. Compliance controls describe the desired configuration settings for deployed resources. A group of compliance controls work together to form a compliance standard (or commonly known as compliance rules).

Compliance standards are enforced to ensure that cloud infrastructure and applications deployed remain compliant. In examples disclosed herein, the compliance system 118 can be hosted in components of the cloud system 102 and/or in a stack of the on-premises system 104. Deploying the compliance system 118 on the cloud system 102 allows compliance standards to be updated as soon as there is a change in the compliance standards. It requires no changes to stack of the on-premises system 104 and cloud compliance system 118 is accessible to all kinds of SDDC deployments (e.g., cloud-connected deployments, cloud-disconnected deployments such as on-premises systems, and dark site deployments).

In examples disclosed herein, compliance packs store compliance standards that are made available in the compliance service 108. The example compliance service 108 is the central place for updates corresponding to compliance packs. When there are modifications to existing compliance standards, such as modifications to compliance controls or new controls introduced, the example compliance service 108 updates the compliance packs to add new compliance rules. In this manner, when new compliance rules are updated on compliance packs, such new compliance rules can be made available via the updated compliance packs. The compliance packs can be used to map rules to corresponding industry security standards and/or regulatory standards for deployed resources.

FIG. 2 is the example compliance service 108 of FIG. 1 which is configured to trigger audit processes or remediation processes on SDDCs and to generate compliance reports of infrastructure components corresponding to the SDDCs. In some examples, users or cloud administrators 112 upload raw data (e.g., event 202) using the example cloud UI 114 and/or the example resources UI 116. In example FIG. 2, the raw data includes SDDC resource configuration data. In examples disclosed herein, SDDC resource configuration data may include resource names, deployment types, host types, resource identifiers, network configurations, etc. However, additional or alternative types of SDDC resource configuration data may be used. In example FIG. 2, when the user 112 inputs SDDC resource configuration data and requests a compliance audit of an SDDC using the cloud console UI 110, the cloud console UI 110 generates a request identified as “Compute Raw Data” (event 204) in FIG. 2 and sends it to the compliance service 108. The example “Compute Raw Data” request (event 204) includes the SDDC resource configuration data for use by the compliance service 108 to perform a compliance audit of the cloud or dark site deployed SDDC. The example compliance service 108 generates an audit result and target compliance standards based on the cloud or dark site SDDC resource configuration data. In examples disclosed herein, the audit result and the target compliance standards are sometimes referred to as the remediation payload. The example compliance service 108 generates an audit report and sends the remediation payload as an example “Send Run Status” message (event 206) to the inter-system message fabric 106. The example inter-system message fabric 106 forwards the notification (event 208) to the WSR 140, which relays the message back to the cloud UI 114 (event 210) to notify the user 112 of the audit progress via the cloud console UI 110.

FIG. 3 is the example compliance agent 150 of FIG. 1. The example compliance agent 150 is configured to evaluate compliance rules and remediate SDDC configurations to achieve compliance for SDDC deployments implemented as on-premises deployments or dark site deployments (e.g., deployments not connected to a cloud). In the illustrated example, an SDDC deployment is managed by the infrastructure provider 160. In some examples, a user or administrator 112 provides user input to the compliance agent 150 to trigger running of SDDC compliance rules (event 302). The example compliance agent 150 requests access to a token and/or credentials (event 304) of the SDDC deployment from the SDDC manager 162. The example compliance agent 150 is also configured to communicate with other on-premises SDDC resources such as the virtual infrastructure management system 166, the network virtualization manager 168, and/or the resource virtualization suite 170 in the infrastructure provider 160. The example compliance agent 150 runs the compliance audit with the compliance rules (event 306) on the SDDC deployment managed by the infrastructure provider 160. The example compliance agent 150 evaluates the compliance rules against the on-premises SDDC and sends the results back to the user 112 as an example “Processed Run Raw Data” message (event 308). In some examples, the compliance agent 150 also sends the results of the compliance evaluation as a compliance report back to the compliance service 108 (FIGS. 1 and 2).

An example compliance report may include one or more of a resource name, a resource status, a resource configuration state, a deviation between a current parameter and a target parameter in a target compliance rule, and/or a resource identifier. In some examples, the resource name includes on-premises hypervisor host names, virtual machine (VM) host names, and/or port group names. In some examples, the resource status includes a compliant or non-compliant status for the resources. The example resource configuration state includes the current configuration state of the resource. For example, the resource configuration state can include the unlock time for a locked-out hypervisor user account, or a virtual local area network identifier (VLAN-id) of a port group. The unlock time for a locked-out user account, or an unexpected VLAN-id of a port group are example indicators of non-compliance. The example deviation includes the difference between the current value of the resource configuration and the desired value from the compliance rule. The example resource identifier includes the unique identifier of the resource under evaluation.

FIG. 4 is a block diagram of an example implementation of the compliance service 108 of FIGS. 1 and 2 to trigger audit or remediation on SDDCs and to render compliance reports of infrastructure components corresponding to those SDDCs. The example compliance service 108 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the example compliance service 108 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

The example compliance service 108 of FIG. 4 includes an example resource configuration controller 404, an example resource registration handler 406, an example resources database 408, an example compliance rules database 412, an example compliance controller 414, an example communication interface 416, and an example audit report generator 418. The example resources database 408 stores resource configurations of the SDDC deployments 160 of FIG. 1. The example compliance rules database 412 stores compliance rules of SDDC deployments (e.g., SDDC deployments managed by the infrastructure provider 160 of FIGS. 1 and 3).

The example compliance service 108 of FIG. 4 is provided with the example resource configuration controller 404 to determine and configure the resource configurations for SDDC deployments 160. The example resource configuration controller 404 configures resources based on configuration update information received from the compliance controller 414.

The example compliance service 108 of FIG. 4 includes the example resource registration handler 406 to register on-premises SDDC resources with the compliance service 108. This allows the example compliance service 108 to send compliance audit requests to registered on-premises SDDCs to evaluate the compliance of deployed SDDCs.

The example compliance service 108 is provided with the compliance controller 414 to update a compliance rules based on target compliance definitions. For example, the compliance controller 414 generates a target compliance rule that corresponds to the SDDC resources 160 based on a target compliance definition. Compliance packs can then be used to store the latest compliance rules for the deployed resources. The compliance rules are a representation of a list of compliance controls for deployed resources. The compliance controls describe the desired configuration settings for the SDDC resources 160. Compliance packs can be used to manage the compliance rules. When there are modifications to existing compliance controls or new controls introduced, the compliance packs are updated with the target compliance rules. In this way, the compliance packs will map to the latest compliance standard. The compliance controller 414 compares the target compliance rule in the compliance packs with a current resource configuration of a resource, and outputs the configuration update information. In examples disclosed herein, the current resource configuration corresponds to a resource in a SDDC.

The example compliance service 108 of FIG. 4 includes the example communication interface 416 to enable the compliance service 108 to communicate with the compliance agent 150 regarding on-premises or dark site resources. The example compliance service 108 uses the communication interface 416 to send compliance audit requests to the compliance agent 150 at the on-premises or dark site resources. The example compliance service 108 also sends remediation recommendations to the on-premises or dark site resources through the communication interface 416.

The example compliance service 108 is provided with the audit report generator 418 to generate audit reports with remediation recommendations. The example compliance service 108 performs compliance audits for deployments under evaluation. After performing a compliance audit, the audit report generator 418 provides an audit report. The audit report includes the audit results and target compliance standards for the deployed resource(s). In some examples, the audit report also includes remediation recommendations for non-compliant resources.

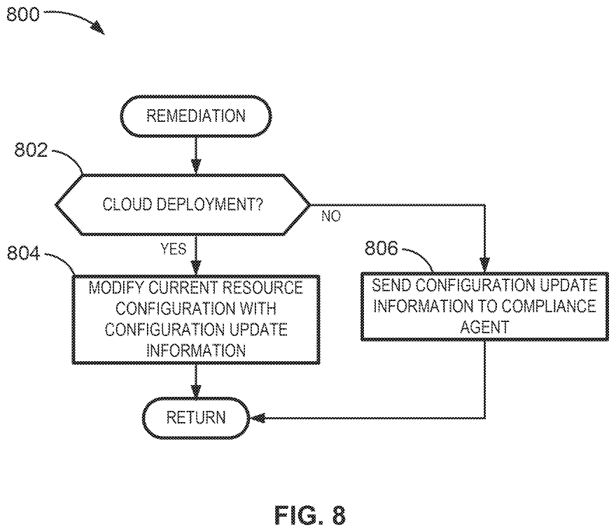

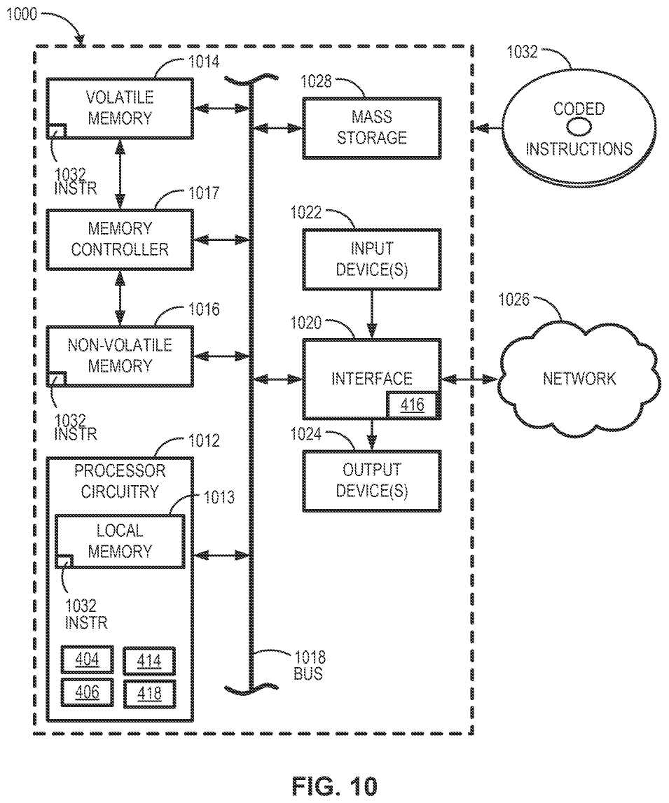

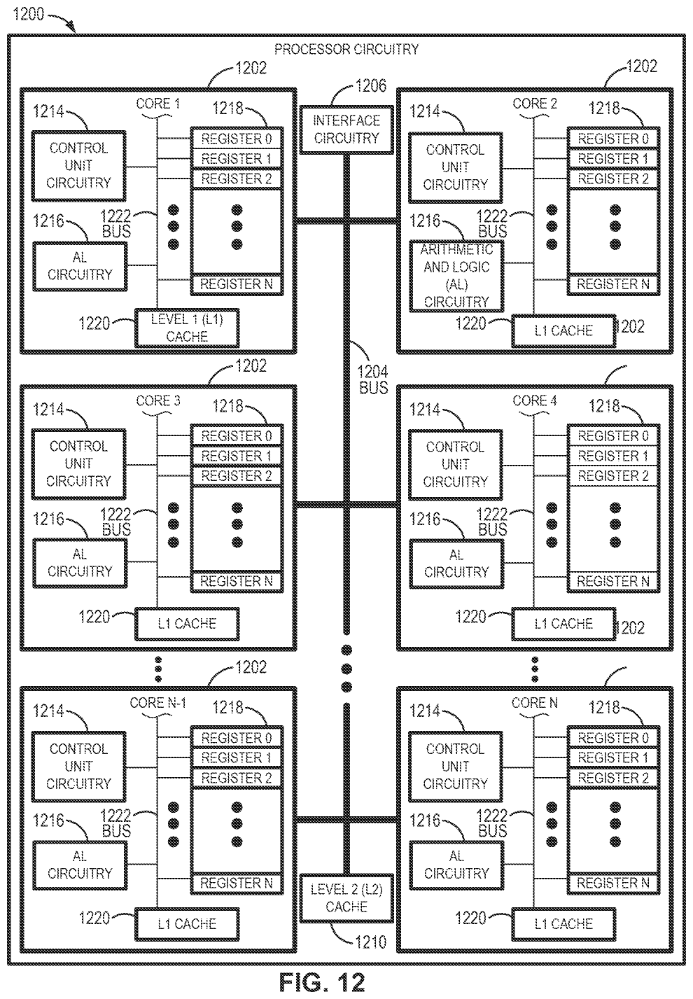

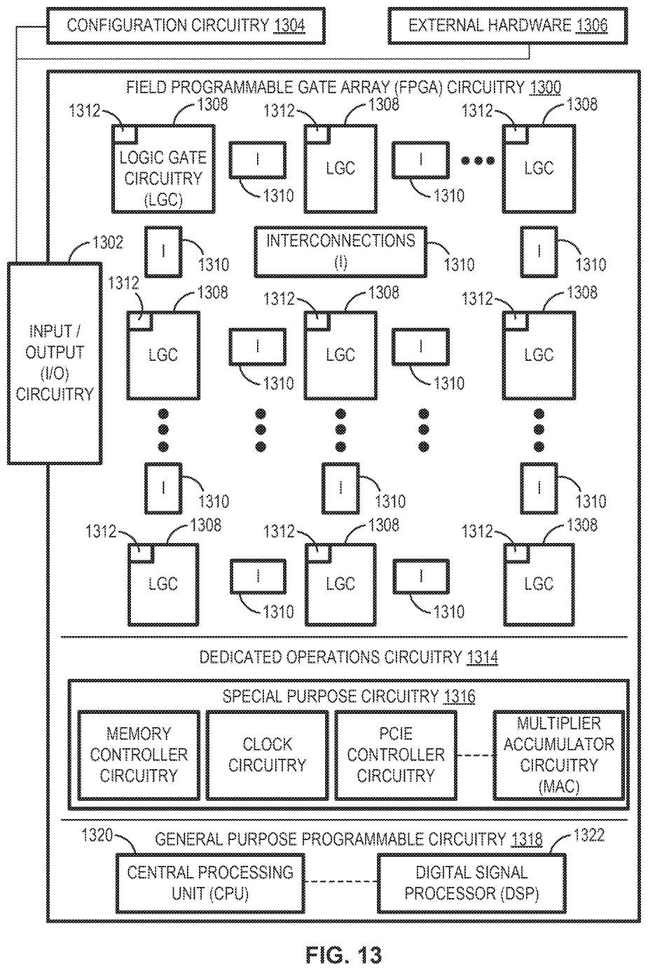

In some examples, the compliance service 108 includes means for configuring a current resource configuration corresponding to a resource in a SDDC. For example, the means for configuring the current resource configuration may be implemented by resource configuration controller circuitry such as the resource configuration controller 404. In some examples, the resource configuration controller 404 may be instantiated by programmable circuitry such as the example programmable circuitry 1012 of FIG. 10. For instance, the resource configuration controller 404 may be instantiated by the example microprocessor 1200 of FIG. 12 executing machine executable instructions such as those implemented by at least block 804 of FIG. 8. In some examples, the resource configuration controller 404 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the resource configuration controller 404 may be instantiated by any other combination of hardware, software, and/or firmware. For example, the resource configuration controller 404 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

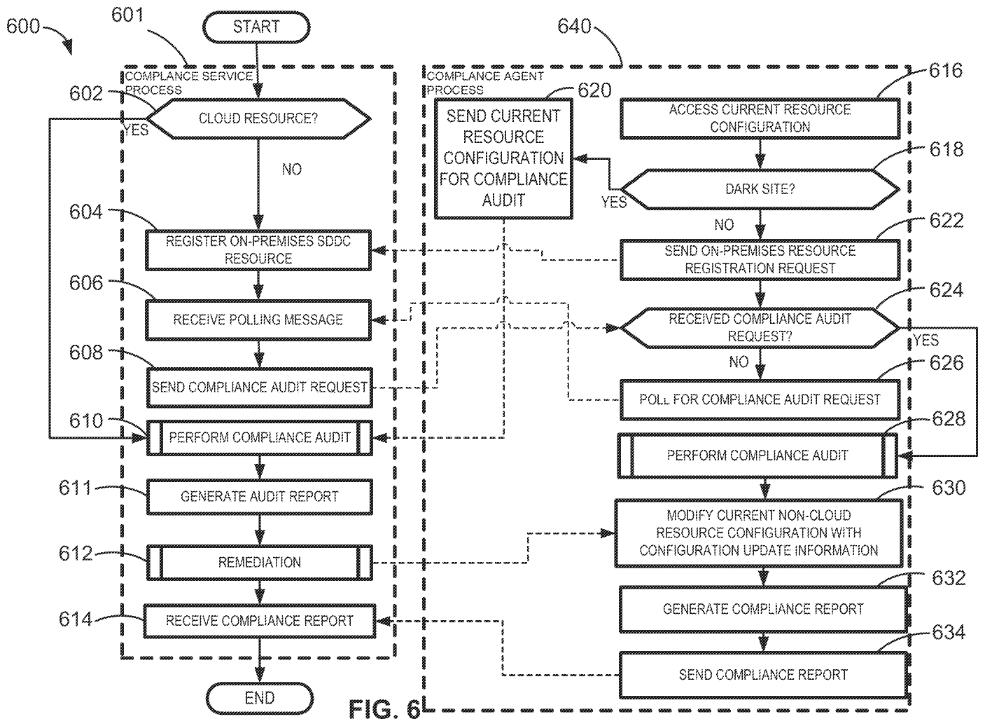

In some examples, the compliance service 108 includes means for registering on-premises SDDC resources with the compliance service 108. For example, the means for registering the on-premises SDDC resources may be implemented by resource registration handler circuitry such as the resource registration handler 406. In some examples, the resource registration handler 406 may be instantiated by programmable circuitry such as the example programmable circuitry 1012 of FIG. 10. For instance, the resource registration handler 406 may be instantiated by the example microprocessor 1200 of FIG. 12 executing machine executable instructions such as those implemented by at least block 604 of FIG. 6. In some examples, the resource registration handler 406 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the resource registration handler 406 may be instantiated by any other combination of hardware, software, and/or firmware. For example, the resource registration handler 406 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

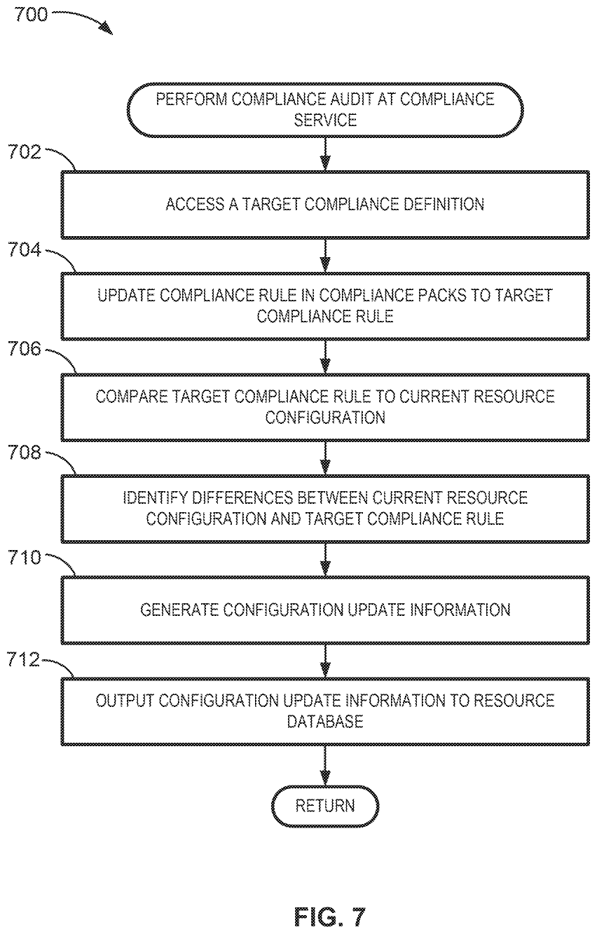

In some examples, the compliance service 108 includes means for updating a compliance rule. For example, the means for updating a compliance rule may be implemented by compliance controller circuitry such as the compliance controller 414. In some examples, the compliance controller 414 may be instantiated by programmable circuitry such as the example programmable circuitry 1012 of FIG. 10. For instance, the compliance controller 414 may be instantiated by the example microprocessor 1200 of FIG. 12 executing machine executable instructions such as those implemented by at least block 704 of FIG. 7. In some examples, the compliance controller 414 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the compliance controller 414 may be instantiated by any other combination of hardware, software, and/or firmware. For example, the compliance controller 414 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the compliance service 108 includes means for sending configuration update information to the compliance agent 150. For example, the means for sending the configuration update information may be implemented by communication interface circuitry such as the communication interface 416. In some examples, the communication interface 416 may be instantiated by programmable circuitry such as the example programmable circuitry 1012 of FIG. 10. For instance, the communication interface 416 may be instantiated by the example microprocessor 1200 of FIG. 12 executing machine executable instructions such as those implemented by at least block 612 of FIG. 6 and block 806 of FIG. 8. In some examples, the communication interface 416 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the communication interface 416 may be instantiated by any other combination of hardware, software, and/or firmware. For example, the communication interface 416 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the compliance service 108 includes means for outputting configuration update information. For example, the means for outputting the configuration update information may be implemented by audit report generator circuitry such as the audit report generator 418. In some examples, the audit report generator 418 may be instantiated by programmable circuitry such as the example programmable circuitry 1012 of FIG. 10. For instance, the audit report generator 418 may be instantiated by the example microprocessor 1200 of FIG. 12 executing machine executable instructions such as those implemented by at least block 712 of FIG. 7. In some examples, the audit report generator 418 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the audit report generator 418 may be instantiated by any other combination of hardware, software, and/or firmware. For example, the audit report generator 418 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the compliance service 108 of FIGS. 1 and 2 is illustrated in FIG. 4, one or more of the elements, processes, and/or devices illustrated in FIG. 4 may be combined, divided, re-arranged, omitted, eliminated, and/or implemented in any other way. Further, the example resource configuration controller 404, the example resource registration handler 406, the example compliance controller 414, the example communication interface 416, the example audit report generator 418 and/or, more generally, the example compliance service 108 of FIGS. 1 and 2, may be implemented by hardware alone or by hardware in combination with software and/or firmware. Thus, for example, any of the example resource configuration controller 404, the example resource registration handler 406, the example compliance controller 414, the example communication interface 416, the example audit report generator 418 and/or, more generally, the example compliance service 108, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example compliance service 108 of FIG. 4 may include one or more elements, processes, and/or devices in addition to, or instead of, those illustrated in FIG. 4, and/or may include more than one of any or all of the illustrated elements, processes and devices.

FIG. 5 is a block diagram of an example implementation of the compliance agent 150 of FIGS. 1 and 3 to evaluate compliance rules and remediate SDDC configurations to achieve compliance for on-premises or dark site SDDC deployments. The example compliance agent 150 of FIG. 5 may be instantiated (e.g., creating an instance of, bring into being for any length of time, materialize, implement, etc.) by programmable circuitry such as a Central Processor Unit (CPU) executing first instructions. Additionally or alternatively, the example compliance agent 150 of FIG. 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

The example compliance agent 150 includes an agent resource configuration controller 502, an agent resource registration handler 504, a resources database 506, a communication interface 508, an agent compliance controller 510, and an agent report generator 512. The example compliance agent 150 is provided with the agent resource configuration controller 502 to access a current resource configuration 516. The example current resource configuration 516 is obtained by the agent resource configuration controller 502 from on-premises or dark site deployed SDDC resources. The example current resource configuration 516 includes a resource name, a deployment type, a host type, a resource identifier, a network configuration, etc. However, additional or alternative types of SDDC resource configuration data may be used. The example agent resource configuration controller 502 uses the current resource configuration 516 to identify the compliance of the deployed SDDC. In this manner, the example agent resource configuration controller 502 can evaluate and compare the current resource configuration against a target compliance rule.

The example agent resource registration handler 504 is configured to register on-premises or dark site SDDCs with the compliance service 108. In this manner, audits can be requested by the compliance service 108 for all SDDCs registered for compliance.

The example resources database 506 is configured to store resource configurations of the SDDC deployments 160 of FIG. 1.

The example communication interface 508 is configured to access compliance definitions 518. The example compliance definitions 518 are obtained by the communication interface 508 from the compliance service 108. The example compliance definitions 518 include target compliance rules which define desired or target configuration settings. The example agent compliance controller 510 uses the compliance definitions 518 to evaluate the target compliance rules against the current resource configuration 516. In this manner, the example agent compliance controller 510 can identify the deviations of the current resource configurations from the compliance evaluation. The deviation is indicative of the non-compliance at an SDDC level.

The example agent report generator 512 is configured to generate compliance reports 520. The example compliance reports 520 include compliance evaluation results. The example agent report generator 512 may send the compliance reports 520 to the compliance service 108.

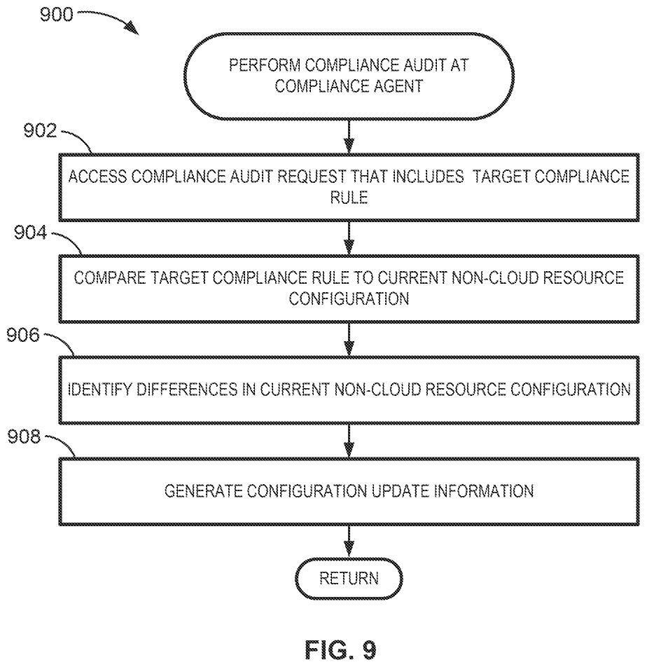

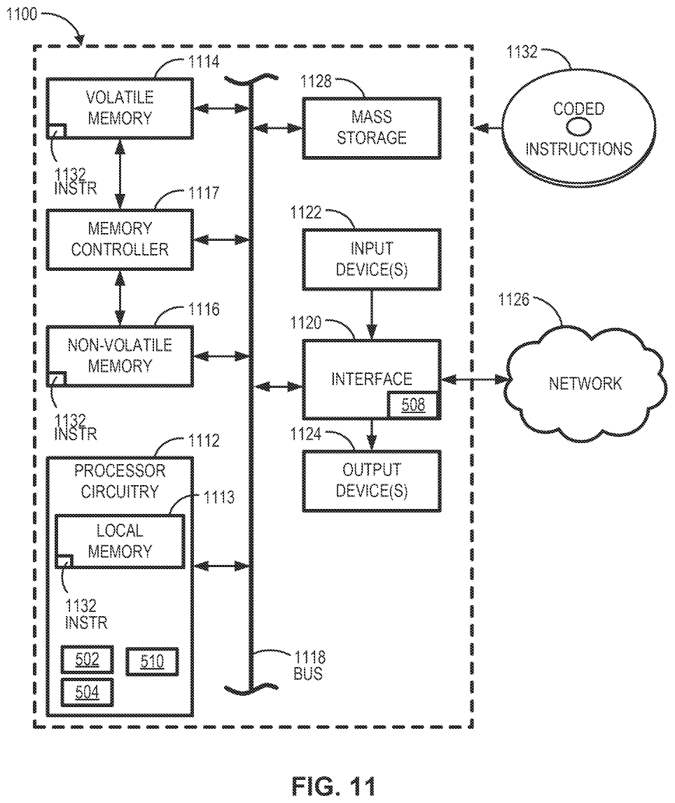

In some examples, the compliance agent 150 includes means for modifying a non-cloud resource configuration (e.g., an on-premises or dark site resource configuration) to satisfy the target compliance rule. For example, the means for modifying may be implemented by agent resource configuration circuitry such as the agent resource configuration controller 502. In some examples, the agent resource configuration controller 502 may be instantiated by programmable circuitry such as the example programmable circuitry 1112 of FIG. 11. For instance, the agent resource configuration controller 502 may be instantiated by the example microprocessor 1200 of FIG. 12 executing machine executable instructions such as those implemented by at least blocks 616, 628 of FIG. 6 and blocks 902-906 of FIG. 9. In some examples, the agent resource configuration controller 502 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the agent resource configuration controller 502 may be instantiated by any other combination of hardware, software, and/or firmware. For example, the agent resource configuration controller 502 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the compliance agent 150 includes means for registering a resource with the compliance service 108. For example, the means for registering may be implemented by agent resource registration handler circuitry such as the agent resource registration handler 504. In some examples, the agent resource registration handler 504 may be instantiated by programmable circuitry such as the example programmable circuitry 1112 of FIG. 11. For instance, the agent resource registration handler 504 may be instantiated by the example microprocessor 1200 of FIG. 12 executing machine executable instructions such as those implemented by at least block 622 of FIG. 6. In some examples, the agent resource registration handler 504 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the agent resource registration handler 504 may be instantiated by any other combination of hardware, software, and/or firmware. For example, the agent resource registration handler 504 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the compliance agent 150 includes means for sending a compliance report to the compliance service 108 through a message broker agent (e.g., the message broker agent 156 of FIG. 1). For example, the means for sending a compliance report may be implemented by communication interface circuitry such as the communication interface 508. In some examples, the communication interface 508 may be instantiated by programmable circuitry such as the example programmable circuitry 1112 of FIG. 11. For instance, the communication interface 508 may be instantiated by the example microprocessor 1200 of FIG. 12 executing machine executable instructions such as those implemented by at least block 634 of FIG. 6. In some examples, the communication interface 508 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the communication interface 508 may be instantiated by any other combination of hardware, software, and/or firmware. For example, the communication interface 508 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the compliance agent 150 includes means for comparing a current non-cloud resource configuration (e.g., an on-premises or dark site resource configuration) to a target compliance rule. For example, the means for comparing may be implemented by agent compliance controller circuitry such as the agent compliance controller 510. In some examples, the agent compliance controller 510 may be instantiated by programmable circuitry such as the example programmable circuitry 1112 of FIG. 11. For instance, the agent compliance controller 510 may be instantiated by the example microprocessor 1200 of FIG. 12 executing machine executable instructions such as those implemented by at least block 904 of FIG. 9. In some examples, the agent compliance controller 510 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the agent compliance controller 510 may be instantiated by any other combination of hardware, software, and/or firmware. For example, the agent compliance controller 510 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the compliance agent 150 includes means for generating a compliance report. For example, the means for generating a compliance report may be implemented by agent report generator circuitry such as the agent report generator 512. In some examples, the agent report generator 512 may be instantiated by programmable circuitry such as the example programmable circuitry 1112 of FIG. 11. For instance, the agent report generator 512 may be instantiated by the example microprocessor 1200 of FIG. 12 executing machine executable instructions such as those implemented by at least block 632 of FIG. 6. In some examples, the agent report generator 512 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the agent report generator 512 may be instantiated by any other combination of hardware, software, and/or firmware. For example, the agent report generator 512 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the compliance agent 150 of FIGS. 1 and 3 is illustrated in FIG. 5, one or more of the elements, processes, and/or devices illustrated in FIG. 5 may be combined, divided, re-arranged, omitted, eliminated, and/or implemented in any other way. Further, the example agent resource configuration controller 502, the example agent resource registration handler 504, the example communication interface 508, the example agent compliance controller 510, the example agent report generator 512 and/or, more generally, the example compliance agent 150 of FIG. 3, may be implemented by hardware alone or by hardware in combination with software and/or firmware. Thus, for example, any of the example agent resource configuration controller 502, the example agent resource registration handler 504, the example communication interface 508, the example agent compliance controller 510, the example agent report generator 512 and/or, more generally, the example compliance agent 150, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example compliance agent 150 of FIG. 5 may include one or more elements, processes, and/or devices in addition to, or instead of, those illustrated in FIG. 5, and/or may include more than one of any or all of the illustrated elements, processes and devices.

Flowcharts representative of example machine readable instructions, which may be executed by programmable circuitry to implement and/or instantiate the compliance service 108 of FIG. 4 and/or representative of example operations which may be performed by programmable circuitry to implement and/or instantiate the compliance service 108 of FIG. 4, are shown in FIGS. 6-8. The machine readable instructions may be one or more executable programs or portion(s) of one or more executable programs for execution by programmable circuitry such as the programmable circuitry 1012 shown in the example processor platform 1000 discussed below in connection with FIG. 10 and/or may be one or more function(s) or portion(s) of functions to be performed by the example programmable circuitry (e.g., an FPGA) discussed below in connection with FIGS. 12 and/or 13. In some examples, the machine readable instructions cause an operation, a task, etc., to be carried out and/or performed in an automated manner in the real world. As used herein, “automated” means without human involvement.

Flowcharts representative of example machine readable instructions, which may be executed by programmable circuitry to implement and/or instantiate the compliance agent 150 of FIG. 5 and/or representative of example operations which may be performed by programmable circuitry to implement and/or instantiate the compliance agent 150 of FIG. 5, are shown in FIGS. 6 and 9. The machine readable instructions may be one or more executable programs or portion(s) of one or more executable programs for execution by programmable circuitry such as the programmable circuitry 1112 shown in the example processor platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine readable instructions cause an operation, a task, etc., to be carried out and/or performed in an automated manner in the real world. As used herein, “automated” means without human involvement.

The programs may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entireties of the programs and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example programs are described with reference to the flowcharts illustrated in FIGS. 6-9, many other methods of implementing the example compliance service 108 and compliance agent 150 may alternatively be used. For example, the order of execution of the blocks of the flowcharts may be changed, and/or some of the blocks described may be changed, eliminated, or combined. Additionally or alternatively, any or all of the blocks of the flowcharts may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6-9 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a flowchart representative of example machine readable instructions and/or example operations 600 that may be executed, instantiated, and/or performed by programmable circuitry to implement the compliance service 108 and the compliance agent 150 of FIGS. 1, 2 and/or 3. In the illustrated example, the flowchart shows a compliance service process 601 and a compliance agent process 640. In the illustrated example, the compliance service process 601 may be performed by the compliance service 108 of FIG. 2 and the compliance agent process 640 may be performed by the compliance agent 150 of FIG. 3. The example processes of FIG. 6 are described in connection with interactions between the compliance service 108 and the compliance agent 150. The example machine-readable instructions and/or the example operations of FIG. 6 begin at block 602, at which the resource configuration controller 404 (FIG. 4) determines whether the SDDC resource is a cloud resource in the example environment 100 (FIG. 1). If the example resource configuration controller 404 detects a cloud resource (block 602: YES), control advances to block 610. If the example resource configuration controller 404 does not detect a cloud resource (block 602: NO), control advances to block 604, at which the example resource registration handler 406 (FIG. 4) registers an on-premises SDDC resource of environment 100. After the on-premises SDDC resource is registered with the compliance service 108, the compliance service 108 can then communicate with the compliance agent 150 via the message broker agent 156 (FIG. 1) through the communication interface 416 (FIG. 4). The example compliance service 108 receives a polling message from the compliance agent 150 (block 606). In example FIG. 6 the polling message polls the compliance service 108 for a compliance audit request. In response to the polling message, the example communication interface 416 sends a compliance audit request to the compliance agent 150 (block 608). For example, the communication interface 416 sends one or more target compliance rules to the compliance agent 150 in the compliance audit request so that the compliance agent 150 can perform the requested compliance audit by analyzing an on-premises SDDC resource configuration for compliance with the one or more target compliance rules.

As shown in the example compliance agent process 640, the example agent compliance controller 510 (FIG. 5) determines whether a message received by the communication interface 508 (FIG. 5) is a compliance audit request (block 624). If the example agent compliance controller 510 determines that the message is not a compliance audit request (block 624: NO), the agent compliance controller 510 polls the compliance service 108 for a compliance audit request (block 626). If the example agent compliance controller 510 determines that the message is a compliance audit request (block 624: YES), control advances to block 628 at which the agent compliance controller 510 performs a compliance audit on the on-premises SDDC resource, as described below in connection with FIG. 9. After the on-premises SDDC compliance audit is performed by the agent compliance controller 510, the example agent resource configuration controller 502 (FIG. 5) modifies the current non-cloud resource configuration with configuration update information (block 630). In some examples, a non-cloud resource configuration can be for an on-premises deployment, and in other examples, a non-cloud resource configuration can be for a dark site deployment. At block 632, the example agent report generator 512 (FIG. 5) generates the compliance report 520 (FIG. 5). At block 634, the example communication interface 508 sends the compliance report 520 to the compliance service 108. At block 614, the example communication interface 416 at the compliance service 108 receives the compliance report 520. The example instructions and/or operations of FIG. 6 end.

Returning back to block 616, the example agent resource configuration controller 502 (FIG. 5) of the compliance agent 150 accesses one or more current resource configurations of one or more on-premises or dark site SDDC resources. At block 618, the example agent resource configuration controller 502 determines whether the SDDC resources reside on a dark site environment. If the example agent resource configuration controller 502 determines that the SDDC resources are on a dark site, the example communication interface 508 (FIG. 5) sends a current resource configuration for a compliance audit (block 620) to the compliance service 108 in the cloud. The example communication interface 416 of the compliance service 108 receives the dark site SDDC current resource configuration for the compliance audit (block 610). The example compliance controller 414 (FIG. 4) performs the compliance audit of the dark site SDDC (block 610), as described below in connection with FIG. 7. After the example compliance service 108 performs the compliance audit at block 610, the example audit report generator 418 generates an audit report 420 (block 611). The example compliance service 108 implements remediation for the dark site SDDC resource (block 612), as described below in connection with FIG. 8. As described below in connection with FIG. 8, if the SDDC resource is not in a cloud deployment (e.g., the SDDC resource is in a cloud-disconnected SDDC deployment), the example communication interface 416 sends a dark site remediation recommendation to the compliance agent 150.

The example communication interface 508 (FIG. 5) of the compliance agent 150 receives the remediation recommendation (block 630). The example agent resource configuration controller 502 modifies the current dark site resource configuration with configuration update information in the remediation recommendation. After modifying the dark site resource configuration, the example agent report generator 512 generates a compliance report 520 (block 632). The example communication interface 508 sends the compliance report 520 to the compliance service 108 at block 634.

Returning to block 618, if the example agent resource configuration controller 502 (FIG. 5) determines that a SDDC resource is not on a dark site, the example agent resource registration handler 504 sends an on-premises SDDC resource registration request to the compliance service 108 in the cloud (block 622). This allows the example compliance service 108 to request compliance evaluations for all registered SDDCs. At block 604 of the compliance service process 601, the example communication interface 416 (FIG. 4) receives the on-premises SDDC resource registration request and the resource registration handler 406 (FIG. 4) registers the on-premises SDDC resource, as described above.

FIG. 7 is a flowchart representative of example machine readable instructions and/or example operations that may be executed, instantiated, and/or performed by example programmable circuitry to implement the compliance service 108 of FIG. 1, FIG. 2 and FIG. 4 to perform a compliance audit. The instructions or operations represented in the flowchart of FIG. 7 may be used to implement block 610 of FIG. 6 to process a compliance audit at the compliance service 108. The example machine-readable instructions and/or the example operations of FIG. 7 begin at block 702 at which the compliance controller 414 (FIG. 4) accesses a target compliance definition. An example target compliance definition includes compliance controls that describe the desired configuration settings for a cloud or dark site SDDC resource. A group of compliance controls together form a compliance standard, also referred to as compliance rules. At block 704, the example compliance controller 414 updates a compliance rule in one or more compliance packs to match a target compliance rule. The compliance controller 414 (FIG. 4) updates compliance rules when there are modifications to existing compliance controls or when new controls are introduced. For example, an administrator or user 112 (FIG. 1) may update or add new compliance controls based on updated regulatory standards, updated industry standards, updated customer policies, updated enterprise policies, etc. After updating the compliance rule in the compliance pack to match the target compliance rule at block 704, the compliance rule in the compliance pack becomes an instance of the target compliance rule. At block 706, the example resource configuration controller 404 (FIG. 4) performs a compliance evaluation by comparing the target compliance rule to a current resource configuration. As described above in connection with FIG. 6, the current resource configuration is sent by the compliance agent 150 to the compliance service 108 at block 620. As also described above in connection with FIG. 6, compliance audits are requested by the compliance service 108 for on-premises SDDC resources registered for compliance (e.g., at block 608 of FIG. 6). At block 708, the example resource configuration controller 404 identifies the differences between the current resource configuration and the target compliance rule. At block 710, the example resource configuration controller 404 generates configuration update information. For example, the resource configuration controller 404 generates the configuration update information based on the differences between the current resource configuration and the target compliance rule. In this manner, the configuration update information includes updated resource configurations to substantially reduce or eliminate the detected differences between the current resource configuration and the target compliance rule in one or more cloud or dark site SDDC resources. At block 712, the resource configuration controller 404 outputs the configuration update information to the resource database 408 (FIG. 4). For example, the generated configuration update information is used to remediate one or more SDDC configurations to desired or target configurations. The example instructions and/or operations of FIG. 7 end and control returns to block 612 of FIG. 6. As described above in connection with FIG. 6, the desired or target configurations are sent by the compliance service 108 to the compliance agent 150 as part of the remediation request, at block 612 (FIG. 6).

FIG. 8 is a flowchart representative of example machine readable instructions and/or example operations that may be executed, instantiated, and/or performed by example programmable circuitry to implement the compliance service 108 of FIG. 1, FIG. 2 and FIG. 4 to perform remediation. The instructions and/or operations represented in the flowchart of FIG. 8 may be used to implement block 612 of FIG. 6 to implement a remediation process at the compliance service 108. The example machine-readable instructions and/or the example operations of FIG. 8 begin at block 802, at which the resource configuration controller 404 (FIG. 4) determines whether the SDDC deployment is a cloud deployment in the example environment 100 (FIG. 1). If the example resource configuration controller 404 FIG. 4) detects a cloud SDDC deployment (block 802: YES), control advances to block 804. At block 804, the example resource configuration controller 404 modifies the current resource configuration with configuration update information. If the example resource configuration controller 404 does not detect a cloud deployment (e.g., the SDDC deployment is a cloud-disconnected SDDC deployment) (block 802: NO), control advances to block 806, at which the example communication interface 416 (FIG. 4) sends the configuration update information to the compliance agent 150 in the example environment 100. The on-premises compliance agent 150 performs remediation by carrying out operations to set the SDDC deployment to the desired or target configurations, as described in block 630 (FIG. 6) above. The example instructions and/or operations of FIG. 8 end.

FIG. 9 is a flowchart representative of example machine readable instructions and/or example operations that may be executed, instantiated, and/or performed by example programmable circuitry to implement the compliance agent 150 of FIG. 1, FIG. 3 and FIG. 5 to perform an agent compliance audit. The instructions and/or operations represented in the flowchart of FIG. 9 may be used to implement block 628 of FIG. 6 to process a compliance audit at the compliance agent 150. The example machine-readable instructions and/or the example operations of FIG. 9 begin at block 902 at which the example agent compliance controller 510 (FIG. 5) accesses a compliance audit request that includes one or more target compliance rules. At block 904, the example agent resource configuration controller 502 (FIG. 5) performs a compliance evaluation by comparing the one or more target compliance rules to a current non-cloud resource configuration. As described above in connection with FIG. 6, the one or more target compliance rules are sent by the compliance service 108 to the compliance agent 150 at block 608. At block 906, the example agent resource configuration controller 502 identifies the differences between the one or more target compliance rules and the current non-cloud resource configuration. At block 908, the example agent resource configuration controller 502 generates the configuration update information to be applied to the SDDC deployment to set the SDDC deployment to the desired or target configuration(s). The example instructions and/or operations of FIG. 9 end.

FIG. 10 is a block diagram of an example programmable circuitry platform 1000 structured to execute and/or instantiate the example machine-readable instructions and/or the example operations of FIGS. 6-8 to implement the compliance service 108 of FIG. 1, FIG. 2 and FIG. 4. The programmable circuitry platform 1000 can be, for example, a server, a personal computer, a workstation, a self-learning machine (e.g., a neural network), or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, DSPs, and/or microcontrollers from any desired family or manufacturer. The programmable circuitry 1012 may be implemented by one or more semiconductor based (e.g., silicon based) devices. In this example, the programmable circuitry 1012 implements the resource configuration controller 404, the resource registration handler 406, the compliance controller 414, and the audit report generator 418 of FIG. 4.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, a keyboard, a button, a mouse, a touchscreen, a trackpad, and/or a trackball.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc. In example FIG. 10, the interface circuitry 1020 implements the communication interface 416 of FIG. 4.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1032, which may be implemented by the machine readable instructions of FIGS. 6-8, may be stored in the mass storage device 1028, in the volatile memory 1014, in the non-volatile memory 1016, and/or on at least one non-transitory computer readable storage medium such as a CD or DVD which may be removable.

FIG. 11 is a block diagram of an example programmable circuitry platform 1100 structured to execute and/or instantiate the example machine-readable instructions and/or the example operations of FIGS. 6 and 9 to implement the compliance agent 150 of FIG. 1, FIG. 3 and FIG. 5. The programmable circuitry platform 1100 can be, for example, a server, a personal computer, a workstation, a self-learning machine (e.g., a neural network), or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, and/or microcontrollers from any desired family or manufacturer. The programmable circuitry 1112 may be implemented by one or more semiconductor based (e.g., silicon based) devices. In this example, the programmable circuitry 1112 implements the agent resource configuration controller 502, the agent resource registration handler 504, the agent compliance controller 510, and the agent report generator 512 of FIG. 5.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, a keyboard, a button, a mouse, a touchscreen, a trackpad, and/or a trackball.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc. In example FIG. 11, the interface circuitry 1120 implements the communication interface 508 of FIG. 5.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1132, which may be implemented by the machine readable instructions of FIGS. 6 and 9, may be stored in the mass storage device 1128, in the volatile memory 1114, in the non-volatile memory 1116, and/or on at least one non-transitory computer readable storage medium such as a CD or DVD which may be removable.

FIG. 12 is a block diagram of an example implementation of the programmable circuitry 1012 of FIG. 10 and the programmable circuitry 1112 of FIG. 11. In this example, the programmable circuitry 1012 of FIG. 10 and the programmable circuitry 1112 of FIG. 11 are implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIGS. 6-8 to effectively instantiate the circuitry of FIGS. 2 and 4 as logic circuits to perform operations corresponding to those machine readable instructions. The microprocessor 1200 executes some or all of the machine-readable instructions of the flowcharts of FIGS. 6 and 9 to effectively instantiate the circuitry of FIGS. 3 and 5 as logic circuits to perform operations corresponding to those machine readable instructions. In some such examples, the circuitry of FIGS. 2-5 are instantiated by the hardware circuits of the microprocessor 1200 in combination with the machine-readable instructions. For example, the microprocessors 1000 and 1100 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 6-9.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1014, 1016 of FIG. 10 and the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCle bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1200, in the same chip package as the microprocessor 1200 and/or in one or more separate packages from the microprocessor 1200.

FIG. 13 is a block diagram of another example implementation of the programmable circuitry 1012 of FIG. 10 and the programmable circuitry 1112 of FIG. 11. In this example, the programmable circuitry 1012 and 1112 are implemented by FPGA circuitry 1300. For example, the FPGA circuitry 1300 may be implemented by an FPGA. The FPGA circuitry 1300 can be used, for example, to perform operations that could otherwise be performed by the example microprocessor 1300 of FIG. 13 executing corresponding machine readable instructions. However, once configured, the FPGA circuitry 1300 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1300 of FIG. 13 described above (which is a general purpose device that may be programmed to execute some or all of the machine readable instructions represented by the flowcharts of FIGS. 6-9 but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 6-9. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 6-9. As such, the FPGA circuitry 1300 may be configured and/or structured to effectively instantiate some or all of the operations/functions corresponding to the machine readable instructions of the flowcharts of FIGS. 6-9 as dedicated logic circuits to perform the operations/functions corresponding to those software instructions in a dedicated manner analogous to an ASIC. Therefore, the FPGA circuitry 1300 may perform the operations/functions corresponding to the some or all of the machine readable instructions of FIGS. 6-9 faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine readable instructions of FIGS. 6-9 and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the programmable circuitry 1012 of FIG. 10, the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1012 of FIG. 10 and the programmable circuitry 1112 of FIG. 11 may additionally be implemented by combining at least the example microprocessor 1200 of FIG. 12 and the example FPGA circuitry 1300 of FIG. 13. In some such hybrid examples, one or more cores 1202 of FIG. 12 may execute a first portion of the machine readable instructions represented by the flowcharts of FIGS. 6-9 to perform first operation(s)/function(s), the FPGA circuitry 1300 of FIG. 13 may be configured and/or structured to perform second operation(s)/function(s) corresponding to a second portion of the machine readable instructions represented by the flowcharts of FIGS. 6-9, and/or an ASIC may be configured and/or structured to perform third operation(s)/function(s) corresponding to a third portion of the machine readable instructions represented by the flowcharts of FIGS. 6-9.

It should be understood that some or all of the circuitry of FIGS. 4-5 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIGS. 4-5 may be instantiated, for example, in one or more threads executing concurrently and/or in series. For example, the microprocessor 1200 of FIG. 12 may execute machine readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIGS. 4-5 may be implemented within one or more virtual machines and/or containers executing on the microprocessor 1200 of FIG. 12.

In some examples, the programmable circuitry 1012 of FIG. 10 and the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1012 of FIG. 10 and the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

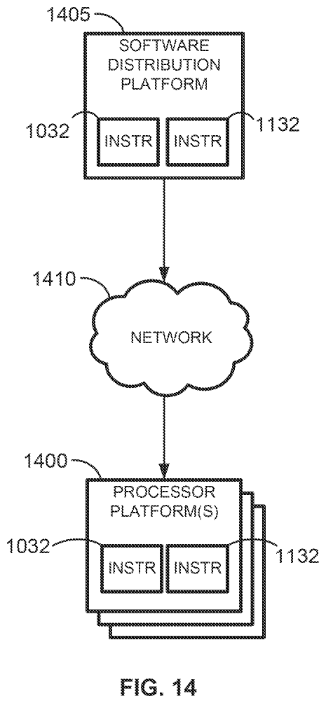

A block diagram illustrating an example software distribution platform 1405 to distribute software such as the example machine readable instructions 1032 of FIG. 10 and the machine readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1032 of FIG. 10 and the machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1032, which may correspond to the example machine readable instructions of FIGS. 6-8, as described above. The storage devices store the machine readable instructions 1132, which may correspond to the example machine readable instructions of FIGS. 6 and 9, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1032 and the machine readable instructions 1132 from the software distribution platform 1405. For example, the software, which may correspond to the example machine readable instructions of FIGS. 6-8, may be downloaded to the example programmable circuitry platform 1000, which is to execute the machine readable instructions 1032 to implement the compliance service. For example, the software, which may correspond to the example machine readable instructions of FIGS. 6 and 9, may be downloaded to the example programmable circuitry platform 1100, which is to execute the machine readable instructions 1132 to implement the compliance agent. In some examples, one or more servers of the software distribution platform 1405 periodically offer, transmit, and/or force updates to the software (e.g., the example machine readable instructions 1032 of FIG. 10 and machine readable instructions 1132 of FIG. 11) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that remediate SDDC resource configurations to desired or target resource configurations. Disclosed systems, apparatus, articles of manufacture, and methods improve the efficiency of using a computing device by allowing a compliance service and a compliance agent to work independent of whether an SDDC deployment is a cloud deployment, an on-premises deployment or a dark site deployment to achieve SDDC resource compliance for cloud deployments, on-premises deployments and dark site deployments. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to manage single-compliance designs for cloud, on-premises and dark site deployments are disclosed herein. Further examples and combinations thereof include the following: Example 1 includes a system comprising interface circuitry, instructions, and programmable circuitry to at least one of instantiate or execute the instructions to update a compliance rule based on a target compliance definition to generate a target compliance rule, the compliance rule corresponding to a resource in a software defined data center, and output configuration update information based on a comparison of the target compliance rule with a current resource configuration, the current resource configuration corresponding to the resource in the software defined data center.

Example 2 includes the system of example 1, wherein the compliance rule corresponds to a first compliance pack, the first compliance pack including a plurality of second compliance rules, the first compliance pack corresponding to a non-cloud resource, the programmable circuitry to access a second compliance pack including a plurality of third compliance rules, the second compliance pack corresponding to a cloud resource.

Example 3 includes the system of example 1, wherein programmable circuitry is to implement a compliance service for a cloud resource and a dark site resource, the programmable circuitry to perform the comparison of the target compliance rule with the current resource configuration.

Example 4 includes the system of example 3, wherein the programmable circuitry is to configure the cloud resource based on the configuration update information.

Example 5 includes the system of example 3, wherein the programmable circuitry is to cause sending of the configuration update information to a compliance agent for a non-cloud resource, the compliance agent to modify a current non-cloud resource configuration to satisfy the target compliance rule.

Example 6 includes the system of example 5, further including the compliance agent to compare the current non-cloud resource configuration to the target compliance rule, the target compliance rule obtained from the compliance service, and modify the current non-cloud resource configuration based on the comparison to cause the non-cloud resource to satisfy the target compliance rule.

Example 7 includes the system of example 6, wherein the non-cloud resource is an on-premises resource or a resource on a dark site.

Example 8 includes the system of example 6, wherein the compliance agent is to register the resource with the compliance service.

Example 9 includes the system of example 6, wherein the compliance agent is to send a compliance report to the compliance service through a message broker agent.

Example 10 includes the system of example 9, wherein the compliance report includes at least one of a resource name, a resource status, a resource configuration state, a deviation between a current parameter and a target parameter in the target compliance rule, or a resource identifier.

Example 11 includes a non-transitory machine-readable medium comprising instruction to cause programmable circuitry to at least update a compliance rule based on a target compliance definition to generate a target compliance rule, the compliance rule corresponding to a resource in a software defined data center, and output configuration update information based on a comparison of the target compliance rule with a current resource configuration, the current resource configuration corresponding to the resource in the software defined data center.

Example 12 includes a non-transitory machine-readable medium of example 11, wherein the compliance rule corresponds to a first compliance pack, the first compliance pack including a plurality of second compliance rules, the first compliance pack corresponding to a non-cloud resource, the instructions to cause the programmable circuitry to access a second compliance pack including a plurality of third compliance rules, the second compliance pack corresponding to a cloud resource.

Example 13 includes a non-transitory machine-readable medium of example 11, wherein the instructions are to cause the programmable circuitry to instantiate a compliance service to compare the target compliance rule with the current resource configuration of a cloud resource and a dark site resource.

Example 14 includes a non-transitory machine-readable medium of example 13, wherein the instructions are to cause the programmable circuitry to configure the cloud resource based on the configuration update information.

Example 15 includes a non-transitory machine-readable medium of example 13, wherein the instructions are to cause the programmable circuitry to cause transmission of the configuration update information to a compliance agent of a non-cloud resource, the configuration update information to cause the compliance agent to modify a current non-cloud resource configuration to satisfy the target compliance rule.

Example 16 includes the non-transitory machine-readable medium of example 13, wherein the instructions are to cause the programmable circuitry to register the resource with the compliance service.

Example 17 includes the non-transitory machine-readable medium of example 11, wherein the instructions are to cause the programmable circuitry to receive a compliance report from a compliance agent through a message broker agent.

Example 18 includes the non-transitory machine-readable medium of example 17, wherein the compliance report includes at least one of a resource name, a resource status, a resource configuration state, a deviation between a current parameter and a target parameter in the target compliance rule, or a resource identifier.

Example 19 includes a method comprising updating, by conducting an operation with programmable circuitry within a cloud environment, a compliance rule based on a target compliance definition to generate a target compliance rule, the compliance rule corresponding to a resource in a software defined data center, and outputting configuration update information based on a comparison of the target compliance rule with a current resource configuration, the current resource configuration corresponding to the resource in the software defined data center.

Example 20 includes the method of example 19, wherein the compliance rule corresponds to a first compliance pack, the first compliance pack including a plurality of second compliance rules, the first compliance pack corresponding to a non-cloud resource, the method further including accessing a second compliance pack including a plurality of third compliance rules, the second compliance pack corresponding to a cloud resource.

Example 21 includes the method of example 19, further including operating a compliance service of a cloud resource and a dark site resource to perform the comparison of the target compliance rule with the current resource configuration.

Example 22 includes the method of example 21, further including operating the compliance service to configure the cloud resource based on the configuration update information.

Example 23 includes the method of example 21, further including operating the compliance service to send the configuration update information to a compliance agent of a non-cloud resource, the compliance agent to modify a current non-cloud resource configuration to satisfy the target compliance rule.

Example 24 includes the method of example 23, further including operating the compliance agent to compare the current non-cloud resource configuration to the target compliance rule, the target compliance rule obtained from the compliance service, and modify the current non-cloud resource configuration based on the comparison to cause the non-cloud resource to satisfy the target compliance rule.

Example 25 includes the method of example 24, wherein the non-cloud resource is an on-premises resource or a resource on a dark site.

Example 26 includes the method of example 21, wherein the compliance service is to register the resource with the compliance service.

Example 27 includes the method of example 19, further including receiving a compliance report from a compliance agent through a message broker agent.

Example 28 includes the method of example 27, wherein the compliance report includes at least one of a resource name, a resource status, a resource configuration state, a deviation between a current parameter and a target parameter in the target compliance rule, or a resource identifier.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A system comprising:
interface circuitry;
instructions; and
programmable circuitry to at least one of instantiate or execute the instructions to:
update a compliance rule based on a target compliance definition to generate a target compliance rule, the compliance rule corresponding to a resource in a software defined data center; and
output configuration update information based on a comparison of the target compliance rule with a current resource configuration, the current resource configuration corresponding to the resource in the software defined data center.

2. The system of claim 1, wherein the compliance rule corresponds to a first compliance pack, the first compliance pack including a plurality of second compliance rules, the first compliance pack corresponding to a non-cloud resource, the programmable circuitry to access a second compliance pack including a plurality of third compliance rules, the second compliance pack corresponding to a cloud resource.

3. The system of claim 1, wherein programmable circuitry is to implement a compliance service for a cloud resource and a dark site resource, the programmable circuitry to perform the comparison of the target compliance rule with the current resource configuration.

4. The system of claim 3, wherein the programmable circuitry is to configure the cloud resource based on the configuration update information.

5. The system of claim 3, wherein the programmable circuitry is to cause sending of the configuration update information to a compliance agent for a non-cloud resource, the compliance agent to modify a current non-cloud resource configuration to satisfy the target compliance rule.

6. The system of claim 5, further including the compliance agent to:
compare the current non-cloud resource configuration to the target compliance rule, the target compliance rule obtained from the compliance service; and
modify the current non-cloud resource configuration based on the comparison to cause the non-cloud resource to satisfy the target compliance rule.

7. The system of claim 6, wherein the non-cloud resource is an on-premises resource or a resource on a dark site.

8. The system of claim 6, wherein the compliance agent is to register the resource with the compliance service.

9. The system of claim 6, wherein the compliance agent is to send a compliance report to the compliance service through a message broker agent.

10. The system of claim 9, wherein the compliance report includes at least one of a resource name, a resource status, a resource configuration state, a deviation between a current parameter and a target parameter in the target compliance rule, or a resource identifier.

11. A non-transitory machine-readable medium comprising instruction to cause programmable circuitry to at least:
update a compliance rule based on a target compliance definition to generate a target compliance rule, the compliance rule corresponding to a resource in a software defined data center; and
output configuration update information based on a comparison of the target compliance rule with a current resource configuration, the current resource configuration corresponding to the resource in the software defined data center.

12. A non-transitory machine-readable medium of claim 11, wherein the compliance rule corresponds to a first compliance pack, the first compliance pack including a plurality of second compliance rules, the first compliance pack corresponding to a non-cloud resource, the instructions to cause the programmable circuitry to access a second compliance pack including a plurality of third compliance rules, the second compliance pack corresponding to a cloud resource.

13. A non-transitory machine-readable medium of claim 11, wherein the instructions are to cause the programmable circuitry to instantiate a compliance service to compare the target compliance rule with the current resource configuration of a cloud resource and a dark site resource.

14. A non-transitory machine-readable medium of claim 13, wherein the instructions are to cause the programmable circuitry to configure the cloud resource based on the configuration update information.

15. A non-transitory machine-readable medium of claim 13, wherein the instructions are to cause the programmable circuitry to cause transmission of the configuration update information to a compliance agent of a non-cloud resource, the configuration update information to cause the compliance agent to modify a current non-cloud resource configuration to satisfy the target compliance rule.

16. The non-transitory machine-readable medium of claim 13, wherein the instructions are to cause the programmable circuitry to register the resource with the compliance service.

17. The non-transitory machine-readable medium of claim 11, wherein the instructions are to cause the programmable circuitry to receive a compliance report from a compliance agent through a message broker agent.

18. The non-transitory machine-readable medium of claim 17, wherein the compliance report includes at least one of a resource name, a resource status, a resource configuration state, a deviation between a current parameter and a target parameter in the target compliance rule, or a resource identifier.

19. A method comprising:
updating, by conducting an operation with programmable circuitry within a cloud environment, a compliance rule based on a target compliance definition to generate a target compliance rule, the compliance rule corresponding to a resource in a software defined data center; and
outputting configuration update information based on a comparison of the target compliance rule with a current resource configuration, the current resource configuration corresponding to the resource in the software defined data center.

20. The method of claim 19, wherein the compliance rule corresponds to a first compliance pack, the first compliance pack including a plurality of second compliance rules, the first compliance pack corresponding to a non-cloud resource, the method further including accessing a second compliance pack including a plurality of third compliance rules, the second compliance pack corresponding to a cloud resource.

21. The method of claim 19, further including operating a compliance service of a cloud resource and a dark site resource to perform the comparison of the target compliance rule with the current resource configuration.

22. The method of claim 21, further including operating the compliance service to configure the cloud resource based on the configuration update information.

23. The method of claim 21, further including operating the compliance service to send the configuration update information to a compliance agent of a non-cloud resource, the compliance agent to modify a current non-cloud resource configuration to satisfy the target compliance rule.

24. The method of claim 23, further including operating the compliance agent to:
compare the current non-cloud resource configuration to the target compliance rule, the target compliance rule obtained from the compliance service; and
modify the current non-cloud resource configuration based on the comparison to cause the non-cloud resource to satisfy the target compliance rule.

25. The method of claim 24, wherein the non-cloud resource is an on-premises resource or a resource on a dark site.

26. The method of claim 21, wherein the compliance service is to register the resource with the compliance service.

27. The method of claim 19, further including receiving a compliance report from a compliance agent through a message broker agent.

28. The method of claim 27, wherein the compliance report includes at least one of a resource name, a resource status, a resource configuration state, a deviation between a current parameter and a target parameter in the target compliance rule, or a resource identifier.
